(19) United States
(12) Patent Application Publication
(10) Pub. No.: US 2021/0283822 A1
(43) Pub. Date: Sep. 16, 2021

(54) FIXING A PREFORM IN STRETCH BLOW MOLDING

(71) Applicant: BROOQ PETROCHEMICAL COMPANY, Doha (QA)

(72) Inventor: Abdulrahman AL-THANI, Doha (QA)

(21) Appl. No.: 16/817,350

(22) Filed: Mar. 12, 2020

(51) Int. Cl. B29C 49/42; B29C 49/32; B29C 49/06

(52) U.S. Cl. CPC B29C 49/421; B29C 49/12; B29C 49/06; B29C 49/32

(57) ABSTRACT

Methods and apparatuses for improving fixing a preform in stretch blow molding. The apparatus may be an apparatus for fixing a preform in stretch blow molding. The apparatus may include a mold body configured to accommodate the preform. The apparatus may also include a pressing type fixing unit inserted into the preform and configured to press the preform in an outward direction and fix the preform to the mold body. The apparatus may further include a gas injection apparatus configured to inject gas into the preform.

### FIELD

Some embodiments may generally relate to blow molding including, for example, stretch blow molding. More specifically, certain embodiments may relate to an apparatus and method for fixing a preform in stretch blow molding.

### BACKGROUND

In general, blow molding is a molding process used in the manufacturing industry to create hollow objects made of plastic. Similar to other molding processes, blow molding may involve the use of heated, liquid material that is injected into a mold cavity under pressure. In certain examples, blow molding is a process in which heated plastic is blown into a mold cavity to create a hollow object. The defining characteristic of blow molding is that it is used to create hollow objects. During this process, raw plastic may first be heated. After the plastic is heated, it may be formed into a parison, and the parison may be secured to the top of the mold. Once secured, air may be blown down into the plastic parison, thereby stretching it across the interior walls of the mold cavity.

Blow molded plastic containers, especially stretch blow molding containers are widely used for water, mineral water, carbonated beverage, beer, and various other liquid products such as detergent, shampoo, cosmetics, and more. When stretch blow molding a container, before the container is finally produced, injection molding a preform is implemented. The preform may be much smaller than the final container product, and may include the opening unit corresponding to the mouth of the container, and the cylindrical body unit. The opening unit may include the open end for hermetic sealing or a combining means with a cover.

After injection molding a preform, the preform may be heated and stretch blown in an axial direction, and blown in a transverse direction. The preform may be fully blown inside a blow mold into a container, of which the upper end is cut and the finished container is produced. A reason why the upper end of the container is blown in the blow mold is because a conventional neck jig grips a neck of the preform after injection molding a preform to move the injection molded preform to the stretch blow mold, and entails scrapes of the gripped part of the neck. This therefore may result in cutting the scraped part.

Furthermore, in a general apparatus for injection molding a multilayer article, a conventional multi-injection machine may be needed. The multi-injection machine may include multi-injection units that include a main injection unit and a sub-injection unit. These injection units may inject two different types of resin. For instance, the main injection unit may inject a first resin and the sub-injection unit may separately inject a second resin.

To prevent the scrape from damaging the finished container, additional area on the top of the neck may be added for the neck jig to grip and to be cut after blow molding. Alternatively, an additional neck ring may be formed on the neck for the preform to be fixed on the blow mold.

In view of the challenges with conventional injection molding machines, there is a need to provide an improved injection blow molding procedure to minimize or eliminate the waste of resin and cutting equipment. There is also a need to eliminate the use of conventional fixing means such as a neck jig that grips a neck of the preform and a neck ring that makes the preform become fixed to the blow mold tighter. In addition, there is a need to provide a pressing type fixing unit that is inserted into the preform, presses the preform in an outward direction, and fixes the preform on the blow mold tighter.

### SUMMARY

One embodiment may be directed to an apparatus for fixing a preform in stretch blow molding. The apparatus may include a mold body configured to accommodate the preform. The apparatus may also include a pressing type fixing apparatus inserted into the preform and configured to press the preform in an outward direction and fix the preform to the mold body. The apparatus may further include a gas injection apparatus configured to inject gas into the preform.

Another embodiment may be directed to a method for fixing a preform in stretch blow molding. The method may include disposing the preform in a mold body, the mold body including a housing. The method may also include inserting a pressing type fixing unit into the preform to fix the preform to the mold body. The method may further include injecting gas from a gas injection apparatus into the preform along a gas route. In addition, the method may include inserting a stretch rod through a moving route of the pressing type fixing unit during the gas injection. The method may also include pressurizing, with the stretch rod, a lower body of the preform in a longitudinal direction. The method may further include cutting the preform at an upper neck after gas injection is completed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 illustrates an apparatus for fixing a preform in blow molding, according to an embodiment.

FIG. 2A illustrates a view of the preform fixed to the apparatus in FIG. 1, according to an embodiment.

FIG. 2B illustrates another view of the preform fixed to the apparatus in FIG. 1, according to an embodiment.

FIG. 3 illustrates a pressing type fixing unit of the apparatus, according to an embodiment.

FIG. 4A illustrates a view of a process of gas injection into the preform, according to an embodiment.

FIG. 4B illustrates a view of another process of gas injection into the preform, according to an embodiment.

FIG. 5 illustrates a view of another pressing type fixing unit, according to an embodiment.

FIG. 6 illustrates a view of a process of stretch blow molding a preform, according to an embodiment.

FIG. 7 illustrates a flow diagram of a method, according to an embodiment.

### DETAILED DESCRIPTION

It will be readily understood that the components of certain example embodiments, as generally described and illustrated in the figures herein, may be arranged and designed in a wide variety of different configurations. The following is a detailed description of some embodiments for synthesizing dry gels and the corresponding activated carbon gels using a thermal reaction to produce dry gels without the use of catalysts or non-water solvents.

The features, structures, or characteristics of example embodiments described throughout this specification may be combined in any suitable manner in one or more example embodiments. For example, the usage of the phrases “certain embodiments,” “an example embodiment,” “some embodiments,” or other similar language, throughout this specification refers to the fact that a particular feature, structure, or characteristic described in connection with an embodiment may be included in at least one embodiment. Thus, appearances of the phrases “in certain embodiments,” “an example embodiment,” “in some embodiments,” “in other embodiments,” or other similar language, throughout this specification do not necessarily all refer to the same group of embodiments, and the described features, structures, or characteristics may be combined in any suitable manner in one or more example embodiments.

Additionally, if desired, the different functions or steps discussed below may be performed in a different order and/or concurrently with each other. Furthermore, if desired, one or more of the described functions or steps may be optional or may be combined. As such, the following description should be considered as merely illustrative of the principles and teachings of certain example embodiments, and not in limitation thereof.

According to certain embodiments when blow molding a preform, a pressing type fixing unit may be inserted into the preform, which presses the preform in an outward direction. As such, certain embodiments may be developed for stretch blow multilayered preforms of higher than five hundred grams per cavity made of resins with lower stretch properties such as glycol modified polyethylene terephthalate (PETG). In addition, certain embodiments may provide an apparatus for fixing a preform in stretch blow molding that may include a mold body accommodating the preform in its inside. The apparatus may also include a pressing type fixing unit that is inserted into the preform, and presses the preform in the outward direction, and then fixes the preform to the mold body.

As described above, an apparatus for fixing a preform in stretch blow molding may be provided. Such an apparatus can eliminate conventional fixing means such as a neck jig that grips a neck of the preform and a neck ring, which makes the preform fixed to the blow mold tighter. As such, conventional methods unnecessarily waste resin and require additional use of cutting equipment. Moreover, when using the neck jig, which grips the additional area on the top of the neck of the multilayer preform, cutting the additional area from the neck after blow molding can expose the intermediary layer of the multilayer container. This may result in imperfections of the barrier function of the intermediary layer.

According to certain embodiments, a protrudent fixing unit may be provided. The protrudent fixing unit may be formed around the inscribed circle of the opening unit of an apparatus for fixing a preform in stretch blow molding. This may ultimately make the preform fixed to the blow mold in a tighter manner. In other embodiments, the pressing type fixing unit may include a moving route through which a stretch rod may move in a longitudinal direction. This may facilitate gas injection into the preform, and make the stretch blow molding easier. In addition, as a gas injection apparatus is integrally formed in the pressing type fixing unit, conventional gas injection means and operating tools may no longer be necessary.

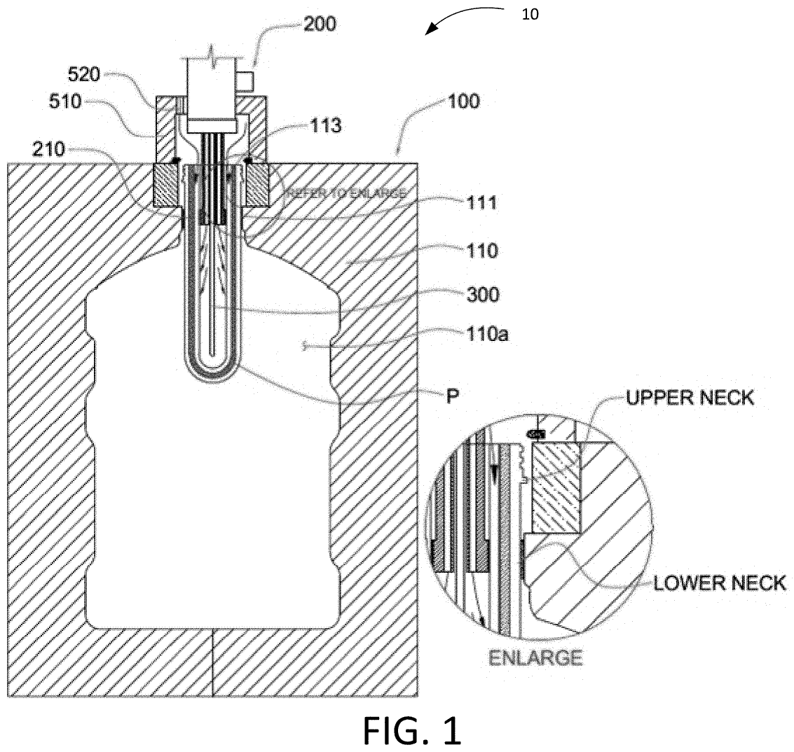

FIG. 1 illustrates an apparatus 10 for fixing a preform P in blow molding, according to an embodiment. In an embodiment, the apparatus 10 for fixing the preform P in stretch blow molding may include a mold body 100 that accommodates the preform P inside of the mold body 100. The apparatus 10 may also include a pressing type fixing apparatus 200, which may be inserted into the preform P and press the preform P in an outward direction. In one embodiment, the pressing type fixing apparatus 200 may also fix the preform P to the mold body 100.

According to an embodiment, the mold body 100 may include a housing 110. The housing 110 may include a molding space 110A inside the housing 110. The mold body 100 may also include an opening 113 that is formed in an upper side of the housing 110. In addition, the mold body 100 may include a protrudent fixing structure 111 formed around an inner surface of the opening 113. According to an embodiment, the protrudent fixing structure 111 may make the preform P be fixed to the blow mold tighter.

In certain embodiments, the preform P may be accommodated in the housing 110. Further, the neck of the preform P may be fixed to the inscribed circle of the opening 113. More specifically, the upper neck (FIG. 1) of the preform P in which a screw thread is formed, may be exposed to the outside of the housing 110, and the lower neck (FIG. 1) below the screw thread may be fixed to the inscribed circle of the opening 113 with the pressing force of the pressing type fixing apparatus 200. In an embodiment, the protrudent fixing structure 111 may be formed around the inscribed circle of the opening 113, which may make the preform P fixed to the blow mold tighter. For instance, the protrudent fixing structure 111 may be formed around the inscribed circle of the opening 113 so that the protrudent fixing structure 111 may be interlocked with multiple fixing pieces 210. As such, it may be possible to fix the preform to the blow mold much tighter. In certain embodiments, the multiple fixing pieces 210 may be made of various suitable materials including, for example, metals or polymers that can withstand the forming temperature. In addition, the materials may be able to give some traction to grip and push the preform as they contract and expand.

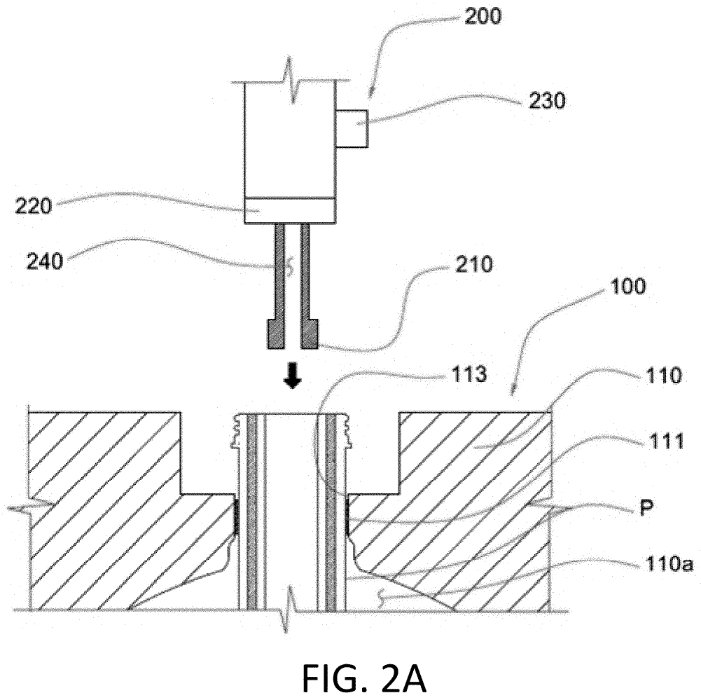

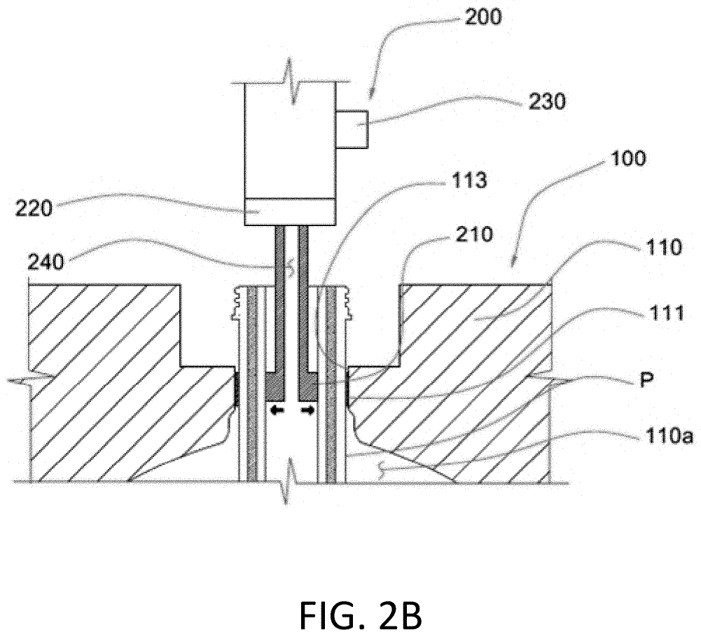

FIGS. 2A and 2B illustrate the pressing type fixing apparatus 200 and preform P fixed on the apparatus, according to an embodiment. As illustrated in FIGS. 2A and 2B, the pressing type fixing apparatus 200 may include multiple fixing pieces 210 that press the preform P in an outward direction, and fixes the preform P to the blow mold. In an embodiment, an interval adjusting unit 220 may be provided to the pressing type fixing apparatus 200. As further illustrated in FIGS. 2A and 2B, the interval adjusting unit 220 may be connected with the multiple fixing pieces 210. In addition, a driving unit 230 may be provided to the pressing type fixing apparatus 200. According to an embodiment, the driving unit 230 may drive the interval adjusting unit 230. In one embodiment, the driving unit 230 may provide a driving force to the interval adjusting unit 220. In certain embodiments, the driving force may be hydraulic or pneumatic. Alternatively, the driving force may be provided with a motor. According to another embodiment, the interval adjusting unit 220 may receive a driving force from the driving unit 230 to operate the multiple fixing pieces 210. In a further embodiment, the interval adjusting unit 220 may contract the multiple fixing pieces 210, and insert them into the preform, and then expand the multiple fixing pieces 210 outward to fix the preform.

In certain embodiments, the multiple fixing pieces 210 may be composed of at least two fixing pieces so that the multiple fixing pieces 210 may be composed of at least two fixing pieces so that the multiple fixing pieces 210 can press the preform P with fully strong force to the inscribed circle of the opening 113. Specifically, in an embodiment, the multiple fixing pieces 210 may be inserted into the preform P, and press the preform P in an outward direction. The multiple fixing pieces 210 also fix the preform P to the mold and body unit 100.

As illustrated in FIGS. 2A and 2B, the pressing type fixing apparatus 200 may further include an interval adjusting unit 220 fixed on top of the multiple fixing pieces 210. In addition, the pressing type fixing apparatus 200 may include a driving unit 230 fixed above the multiple fixing pieces 210. According to an embodiment, the interval adjusting unit 220 may either press the preform P tighter by moving the multiple fixing pieces 210 outward, or release the preform P by moving the multiple fixing pieces 210 inward with a driving force delivered by the driving unit 230. In an example embodiment, the multiple fixing pieces 210 may be made into various shapes if pressurization is possible, and the driving unit 230 may be implemented with commonly used driving devices including, for example, air pressure, oil pressure, or motors.

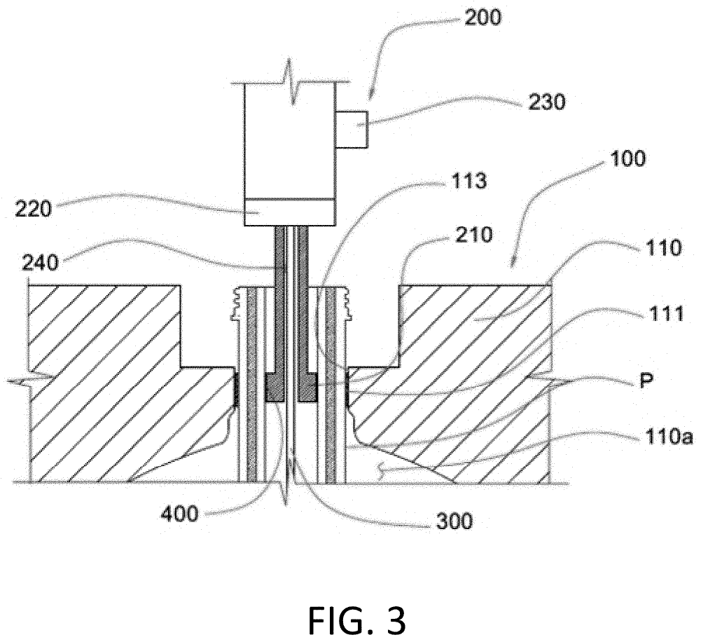

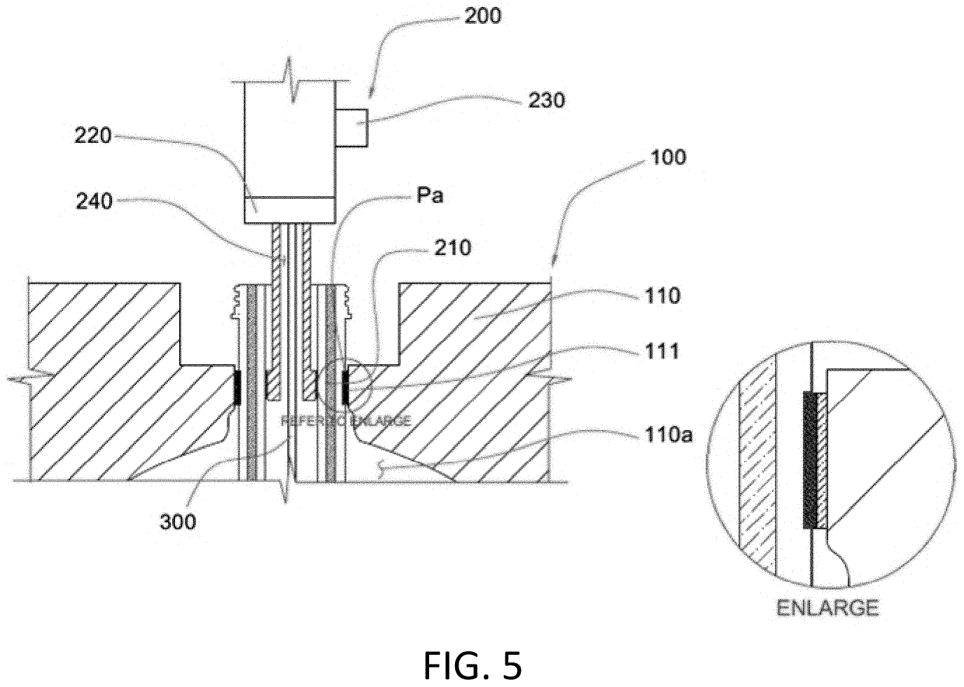

FIG. 3 illustrates a pressing type fixing unit, according to an embodiment. As illustrated in FIG. 3, the pressing type fixing apparatus 200 may include multiple fixing pieces 210. In addition, the multiple fixing pieces 210 may include a skid-proof unit 400. According to an embodiment, the skid-proof unit 400 may prevent skid at the contact area with the preform P. In addition, the skid-proof unit 400 may be made of various materials including, for example, a material may have a higher frictional force than that of the preform, and a higher heat distortion temperature than the temperature at which the preform is blow molded inside the mold body 100. According to another embodiment, the multiple fixing pieces 210 may include a protrusion unit or a groove unit Pa (as illustrated in FIG. 5) on its outer surface so that the multiple fixing pieces 210 can fix the preform P much tighter to the mold body 100.

As further illustrated in FIG. 3, the pressing type fixing apparatus 200 may include a moving route 240 through which a stretch rod 300 can move. In an embodiment, the moving route 240 may be formed so that the stretch rod 300 can slide. Moreover, in another embodiment, the stretch rod 300 may be located in the center of the pressing type fixing apparatus 200 so that the stretch rod 300 does not interrupt the transversal movement of the multiple fixing pieces 210 inward or outward. In another embodiment, the upper neck of the preform P (see FIG. 1) in which a screw thread is formed may be exposed to the outside of the housing 110. In addition, the lower neck of the preform P (see FIG. 1) below the screw head may be fixed to the inscribed circle of the opening 113 with the pressing force of the pressing type fixing apparatus 200.

According to certain embodiments, the preform P may be accommodated in the housing 110, and the neck of the preform P may be fixed to the inscribed circle of the opening 113. For instance, as previously noted, the upper neck of the preform P in which a screw thread is formed, may be exposed to the outside of the housing 110, and the lower neck below the screw thread may be fixed to the inscribed circle of the opening 113 with the pressing force of the pressing type fixing apparatus 200.

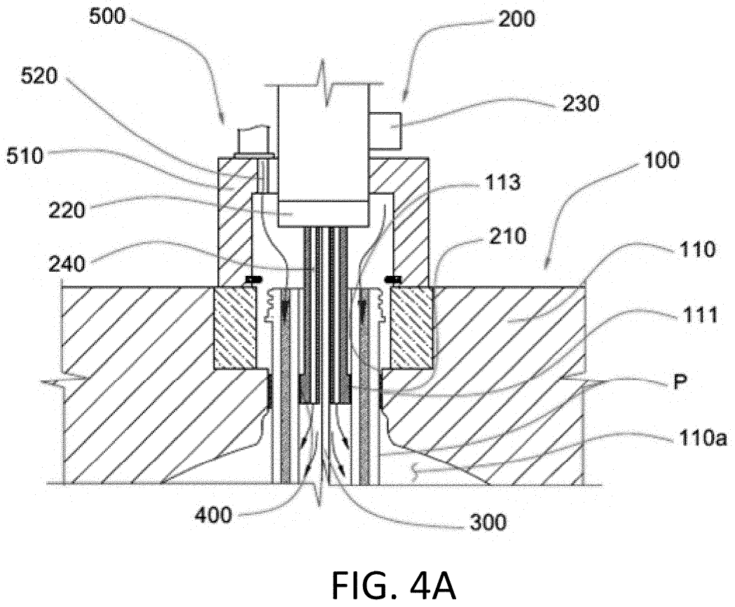

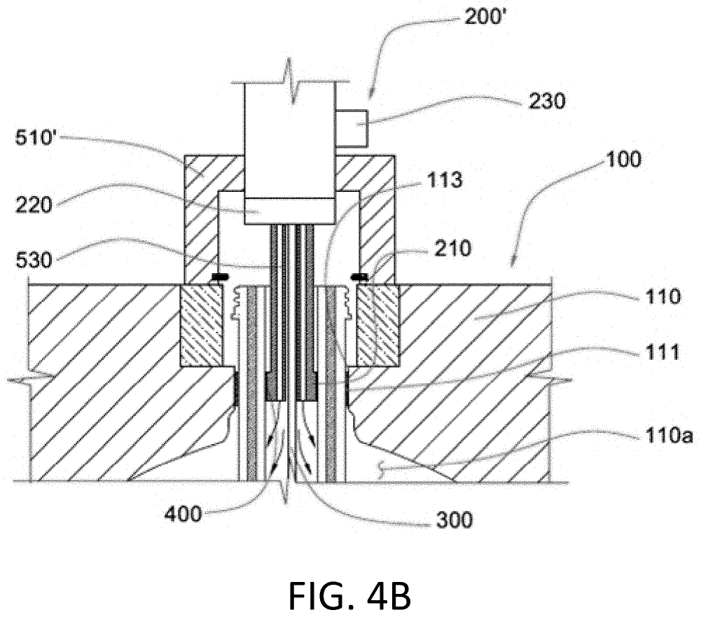

FIG. 4A illustrates a process of gas injection into the preform P, according to an embodiment. For example, in one embodiment, gas may be injected into the preform P fixed to the inscribed circle of the opening 113. Further, the gas may be injected to shape a container according to a molding space 110a of the mold body 100. In an embodiment, the gas injection apparatus 500 may include a sealing cap 510 that prevents gas leakage into the outside during gas injection into the preform P. According to one embodiment, a sealing material such as an O-ring may be used to seal the cap 510 to provide a secured and air-tight environment. Further, a gas route 520 may be formed in the upper side of the sealing cap 510. According to an embodiment, the gas injection apparatus 500 may close the opening 113 with the sealing cap 510 so that injected gas cannot leak to the outside of the preform P during stretch blow molding the preform P.

According to certain embodiments, during the gas injection process by the gas injection apparatus 500, the stretch rod 300 may be inserted together through the moving route 240 formed with the pressing type fixing apparatus 200. In addition, the stretch rod 300 may pressurize the lower body of the preform P in the longitudinal direction, thereby facilitating the stretch blow molding. More specifically, after closing the opening 113 with the sealing cap 510, the gas injection apparatus 500 may inject gas into the inside of the preform P, and the injected gas may flow through the neck of the preform P thereby shaping a container product according to the molding space 110a of the mold body 100. As previously noted, during this time, the stretch rod 300 may pressurize the lower body of the preform P in the longitudinal direction, thus facilitating stretch blow molding.

FIG. 4B illustrates a view of another process of gas injection into the preform, according to an embodiment. In particular, FIG. 4B illustrates a process of gas injection into the inside of the preform P, according to an embodiment. In this case, the pressing type fixing apparatus 200′ may include a gas injection tube 530 beside the multiple fixing pieces 210. According to this configuration, the pressing type fixing apparatus 200 can fix the neck of the preform P and gas injection into the preform P at the same time. In one embodiment, the gas injection tube 530 may be equipped inside the pressing type fixing apparatus 200. In such a case, the multiple fixing pieces 210 may function both as fixing pieces and a gas injection tube. With this configuration, the pressing type fixing apparatus 200 may inject gas into the preform P with no use of the gas injection apparatus 500. In addition, the pressing type fixing apparatus 200 may include a closing cap 510′ to provide a secured air-tight environment.

FIG. 5 illustrates a processing type fixing unit, according to another embodiment. In particular, FIG. 5 illustrates the preform P, which includes fixing groove Pa so that the protrudent fixing structure 111 may be inserted into the fixing groove 91. In addition, FIG. 5 illustrates the multiple fixing pieces 210, which may include a screw thread, according to an embodiment.

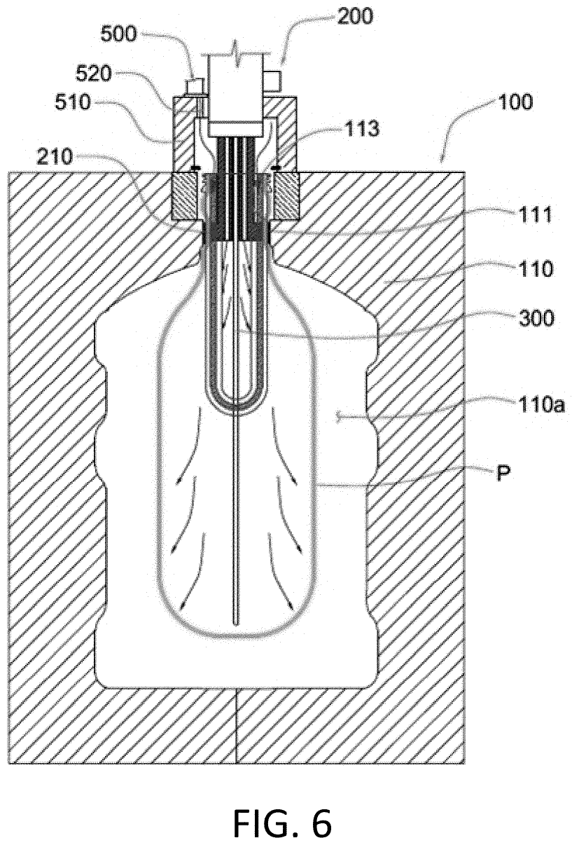

FIG. 6 illustrates a view of a process of stretch blow molding a preform, according to an embodiment.

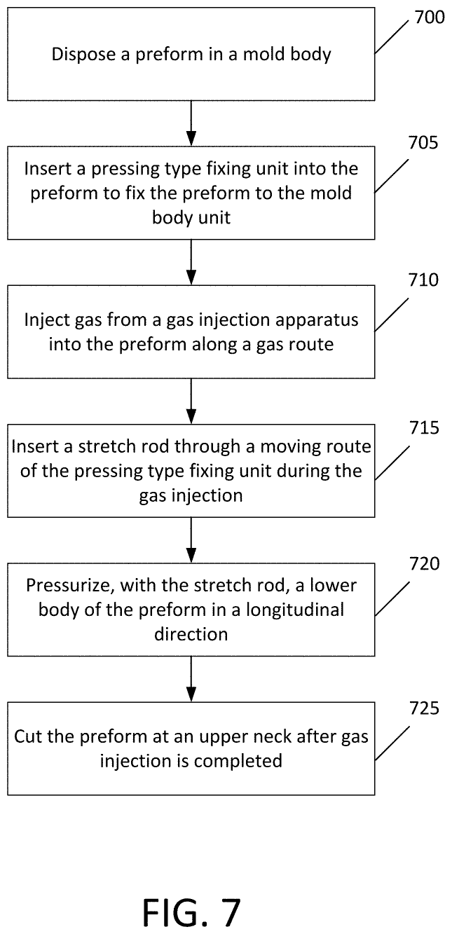

FIG. 7 illustrates a flow diagram of a method, according to an embodiment. According to certain embodiments, the method may be performed by the apparatus for fixing a preform in stretch blow molding, as described herein. As illustrated in FIG. 7, the method may include, at 700, disposing a preform in a mold body. In an embodiment, the mold body may include a housing. The method may also include, at 705, inserting a pressing type fixing apparatus into the preform to fix the preform to the mold body. The method may further include, at 710, injecting gas from a gas injection apparatus into the preform along a gas route. At 715, the method may include inserting a stretch rod through a moving route of the pressing type fixing apparatus during the gas injection. In addition, at 720, the method may include pressurizing, with the stretch rod, a lower body of the preform in a longitudinal direction. Further, at 725, the method may include cutting the preform at an upper neck after gas injection is completed.

According to an embodiment, the gas injected from the gas injection apparatus may be attached to the housing. According to another embodiment, the gas injection apparatus may include a sealing cap. In an embodiment, the method may further include forming a screw thread at the upper neck of the preform. In another embodiment, the method may include exposing the upper neck to an exterior of the mold body. In a further embodiment, the method may include disposing a lower neck of the preform in an interior space of the mold body. According to an embodiment, the method may also include forming a protrudent fixing unit around an inscribed circle of an opening unit formed on an upper side of the housing. According to another embodiment, the gas may be injected from a gas injection tube attached to the pressing type fixing apparatus.

Certain embodiments described herein provide several technical improvements, enhancements, and/or advantages. In some example embodiments, it may be possible to provide an apparatus for fixing a preform in stretch blow molding that may prevent unnecessary waste of resin and additional use of cutting equipment, which may result in reducing the cost of production and reducing working hours. Certain embodiments may also provide a pressing type fixing apparatus that is inserted into the preform, presses the preform in an outward direction, and fixes the preform on the blow mold tighter. According to other embodiments, it may be possible to eliminate conventional fixing means such as a neck jig, which grips a neck of the preform and a neck ring that makes the preform fixed to the blow mold tighter. In this manner, it may be possible to prevent unnecessary waste of resin and additional use of cutting equipment. Additionally, certain embodiments may prevent imperfections occurring in the barrier function of the intermediary layer of the multilayer container. In other embodiments, a gas injection apparatus may be integrally formed in the pressing type fixing apparatus, which may eliminate conventional gas injection means and operating tools.

One having ordinary skill in the art will readily understand that the invention as discussed above may be practiced with steps in a different order, and/or with hardware elements in configurations which are different than those which are disclosed. Therefore, although the invention has been described based upon these example embodiments, it would be apparent to those of skill in the art that certain modifications, variations, and alternative constructions would be apparent, while remaining within the spirit and scope of example embodiments.

We claim:

1. An apparatus for fixing a preform in stretch blow molding, comprising:
a mold body configured to accommodate the preform;
a pressing type fixing apparatus inserted into the preform and configured to press the preform in an outward direction and fix the preform to the mold body; and
a gas injection apparatus configured to inject gas into the preform.

2. The apparatus according to claim 1, further comprising a stretch rod disposed in a moving route of the pressing type fixing apparatus.

3. The apparatus according to claim 1, wherein the pressing type fixing apparatus comprises:
a plurality of fixing pieces, and an interval adjusting unit, wherein the interval adjusting unit is connected with the plurality of fixing pieces; and
a driving unit configured to drive the interval adjusting unit.

4. The apparatus according to claim 3, wherein the plurality of fixing pieces comprises a ski-proof unit configured to prevent skid at a contact area with the preform.

5. The apparatus according to claim 1, wherein the mold body comprises:
a housing that defines a molding space inside;
an opening unit disposed at an upper side of the housing; and
a protrudent fixing unit disposed around the opening unit.

6. The apparatus according to claim 1, wherein the preform comprises glycol modified polyethylene terephthalate.

7. A method for fixing a preform in stretch blow molding, comprising:
disposing the preform in a mold body, the mold body comprising a housing;
inserting a pressing type fixing unit into the preform to fix the preform to the mold body;
injecting gas from a gas injection apparatus into the preform along a gas route;
inserting a stretch rod through a moving route of the pressing type fixing unit during the gas injection;
pressurizing, with the stretch rod, a lower body of the preform in a longitudinal direction; and
cutting the preform at an upper neck after gas injection is completed.

8. The method for fixing a preform in stretch blow molding according to claim 7, wherein the gas is injected from the gas injection apparatus attached to the housing.

9. The method for fixing a preform in stretch blow molding according to claim 7, wherein the gas injection apparatus comprises a sealing cap.

10. The method for fixing a preform in stretch blow molding according to claim 7, further comprising forming a screw thread at the upper neck of the preform.

11. The method for fixing a preform in stretch blow molding, according to claim 7, further comprising exposing the upper neck to an exterior of the mold body.

12. The method for fixing a preform in stretch blow molding, according to claim 7, further comprising disposing a lower neck of the preform in an interior space of the mold body.

13. The method for fixing a preform in stretch blow molding according to claim 7, further comprising forming a protrudent fixing unit around an inscribed circle of an opening unit formed on an upper side of the housing.

14. The method for fixing a preform in stretch blow molding according to claim 7, wherein the gas is injected from a gas injection tube attached to the pressing type fixing apparatus.
